(19) United States
(12) Patent Application Publication
(10) Pub. No.: US 2008/0234104 A1
(43) Pub. Date: Sep. 25, 2008

(54) Method and Device For Controlling Engine Torque and Speed

(75) Inventors: Sixten Berglund, Torslanda (SE); Peter Templin, Vastra Frolunda (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/064,821

(22) PCT Filed: Sep. 1, 2006
(86) PCT No.: PCT/SE2006/001008

§ 371 Date: Feb. 26, 2008

Related U.S. Application Data
(60) Provisional application No. 60/596,214, filed on Sep. 8, 2005.

(51) Int. Cl. F16H 59/24

(52) U.S. Cl. 477/123

(57) ABSTRACT

A method and device for modifying throttle control characteristics of a throttle control in a vehicle, the vehicle including an engine coupled to engine driven vehicle wheels via a stepped gear mechanical transmission, and where requested engine torque at a given engine speed of the engine is controlled as a function of positions of the throttle control. When sensing a gear shift to a vehicle high speed gear, a control unit modifies the characteristics so the engine torque and engine speed will be controlled via said throttle control along a first set of relatively flat curves, when the curves are plotted in a diagram with engine torque on the y-axis and engine speed on the x-axis. When sensing a gear shift to a vehicle low speed gear, the characteristics are modified so the engine torque and engine speed will be controlled via the throttle control along a second set of curves that are steeper than the first set of curves, so that when driving with a vehicle low speed and for a certain change in engine speed, a greater change in torque will be provided than when controlling is done in accordance with the first set of curves.

The present application is the U.S. National Stage application of PCT/SE2006/001008, filed Sep. 1, 2006, which claims priority of U.S. Provisional Application No. 60/596,214, filed Sep. 8, 2005.

### BACKGROUND AND SUMMARY

The present invention relates to a method and drive unit for a motor vehicle, comprising an internal combustion engine, a manually adjustable throttle control and an electronic engine control unit for controlling the engine torque and engine speed, and to which the throttle control is electrically connected, and in which engine control unit a first and a second throttle control characteristics are stored. Said engine torque and engine speed are controlled via said throttle control and one of said throttle control characteristics.

It has become more and more common in motor vehicles of late to replace a mechanical wire linkage system coupling the accelerator pedal position or its movement to the engine throttle and fuel engine system with electronic transmission for controlling engine torque and speed. A sensor coupled to the accelerator pedal provides signals representing throttle control position to an electronic control unit, commonly in the form of a microprocessor, which controls engine functions as a function of the sensed throttle control position. To achieve this, throttle control characteristics mapping engine torque as a function of r.p.m. for various throttle control positions is stored in the control unit.

Automatic transmissions of the Automatic Mechanical Transmission (AMT) type have become increasingly common in heavy-duty vehicles as microcomputer technology has continued to advance and has made it possible, with a control computer and a number of control elements, for example servo motors, to precision-control the engine speed, the connection and disconnection of an automated clutch between engine and gearbox and coupling members of the gearbox, relative to one another, so that smooth gearshift is always obtained at the correct rev speed. The advantage with this type of automatic transmission compared to a traditional automatic transmission based on a set of planetary gears and with a hydrodynamic torque converter on the input side is firstly that, particularly as regards use in heavy vehicles, it is simpler and more robust and can be produced at substantially lower cost, and secondly that it has higher efficiency, which means the prospect of lower fuel consumption.

WO03048547 shows an arrangement where a computer matrix plotting engine torque as a function of engine speed for various throttle control positions is changed between two different matrixes depending on whether the vehicle is accelerating or not. This is achieved by that a first and a second computer matrix (or throttle control characteristics) are stored in the engine control unit. The curves for the throttle control positions in the diagram of the second matrix have a steeper slope than the curves in the diagram of the first matrix. The engine control unit is disposed, at a setting of: the throttle control giving rise to an acceleration exceeding a predetermined minimum acceleration, to control the engine torque and engine speed along the curves in the first matrix diagram and, upon a signal indicating a drop below said minimum acceleration, to control the engine torque and engine speed along the curves in the second matrix diagram, so that for a certain change in engine speed, a greater change in torque will be provided than when controlling along the curves in the first matrix diagram.

The first matrix in WO03048547 is designed so that the engine control unit provides even acceleration for each throttle control position, i.e. with as little jerking as possible when gear shifting during the acceleration. This is achieved with relatively flat throttle control curves. At the same time the control unit, after having reached the target vehicle velocity at constant throttle control position, maintains this velocity with very small deviations. This is achieved with the second matrix where throttle control position curves are as steep as possible. Steep curves provide large increases in torque for a minor drop in r.p.m. and speed.

The practical experience of the acceleration dependent change between the two different matrixes according to the arrangement in WO03048547 has not been satisfying. When driving at low approximately constant vehicle speeds and the throttle being controlled via a matrix with flat throttle control curves gives the driver difficulties in trying to keep constant speed in lower gears. This is due to that a small torque change gives a relatively big vehicle speed change.

It is desirable to improve the drivability especially at low approximately constant vehicle speeds.

The method and device according to an aspect the invention is for modifying throttle control characteristics of a throttle control in a vehicle, said vehicle comprising an engine coupled to engine driven vehicle wheels via a stepped gear mechanical transmission, and where requested engine torque at a given engine speed of said engine is controlled as a function of positions of said throttle control. The invention is characterized by; when a control unit is sensing a gear shift to a vehicle high speed gear, said control unit is disposed to modify said characteristics so the engine torque and engine speed will be controlled via said throttle control along a first set of relatively flat curves, when said curves are plotted in a diagram with engine torque on the y-axis and engine speed on the x-axis, and when sensing a gear shift to a vehicle low speed gear, modify said characteristics so the engine torque and engine speed will be controlled via said throttle control along a second set of curves, that are steeper than said first set of curves, so that when driving with a vehicle low speed and for a certain change in engine speed, a greater change in torque will be provided than when controlling is done in accordance with the first set of curves.

The advantage with the method and device according to an aspect of the invention is that a change of the throttle control characteristics so that the controlling will be performed in accordance with the steep curves at vehicle low speed gears, gives a much smaller speed variation with a corresponding torque change compared to said flat curves. The overall drivability of the vehicle increases.

### BRIEF DESCRIPTION OF THE DRAWINGS

The present invention will be described in greater detail below with reference to the accompanying drawings which, for the purpose of exemplification, shows further preferred embodiments of the invention and also the technical background, and in which:

FIG. 1 shows a schematic representation of an internal combustion engine with connected clutch and gearbox,

FIG. 2 is a diagram showing first and second set of curves along which corresponding throttle control characteristics according to the invention are controlled, and

FIG. 3 shows a flowchart of the sequence for performing shifts between said throttle control characteristics according to the invention.

### DETAILED DESCRIPTION

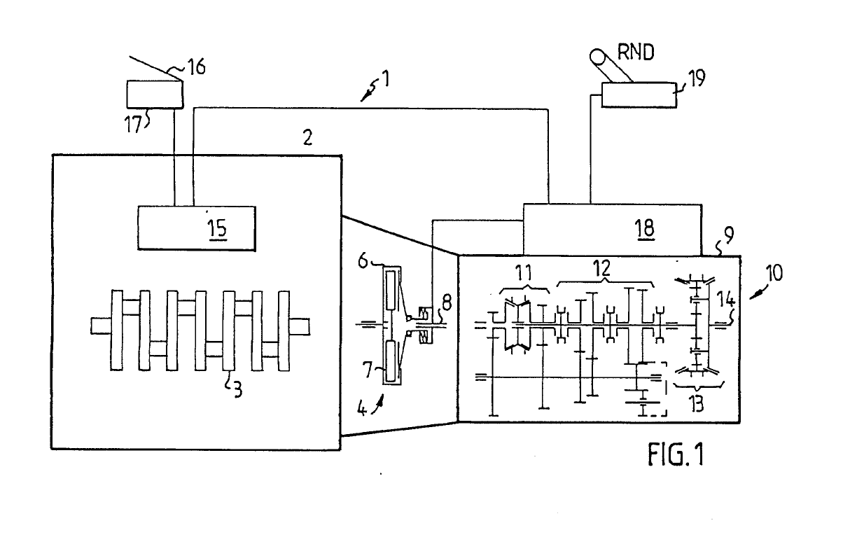

The drive unit 1 shown in FIG. 1 comprises in the embodiment shown a six-cylinder engine 2, e.g. a diesel engine, the crankshaft 3 of which is coupled to an automated drive disc clutch generally designated 4, which is enclosed in a clutch housing 6. The crankshaft 3 is non-rotatably joined to the clutch housing 6 of the clutch 4, while its disc 7 is non rotatably joined to an input shaft 8, which is rotatably mounted in the housing 9 of an autoshift gearbox generally designated 10, which in the example has a splitter group 11, a main group 12 and a range group 13. The gearbox 10 has an output shaft 14 intended to be drivably coupled to the vehicle driving wheels (not shown), e.g. via a propeller shaft (not shown). The engine 2 is controlled by an electronic engine control unit 15, which can comprise a microprocessor, in response to signals from a position sensor 17 coupled to a throttle control 16, e.g. an accelerator pedal. The transmission 10 is controlled by a transmission control unit 18, which can comprise a microprocessor in response, firstly, to the position of a manual gear selector 19 and, secondly, to control parameters including accelerator pedal position and engine r.p.m. fed into the control unit 18. The transmission control unit 18 communicates with the engine control unit 15 as well. The gear selector 19 has a neutral position N and two automatic drive positions D (forward) and R (reverse) and possibly other positions, permitting the driver to shift manually. In positions R and D, the transmission control unit 18 shifts automatically when starting and driving.

In the automatic mode gear selections and shift decisions are made by the control unit 18 based on certain measured and/or calculated parameters such as vehicle speed, engine speed, rate of change of vehicle speed, rate of change of engine speed, throttle control position, rate of change of throttle control position, actuation of a vehicle braking system, currently engaged gear ratio and the like are known from prior art.

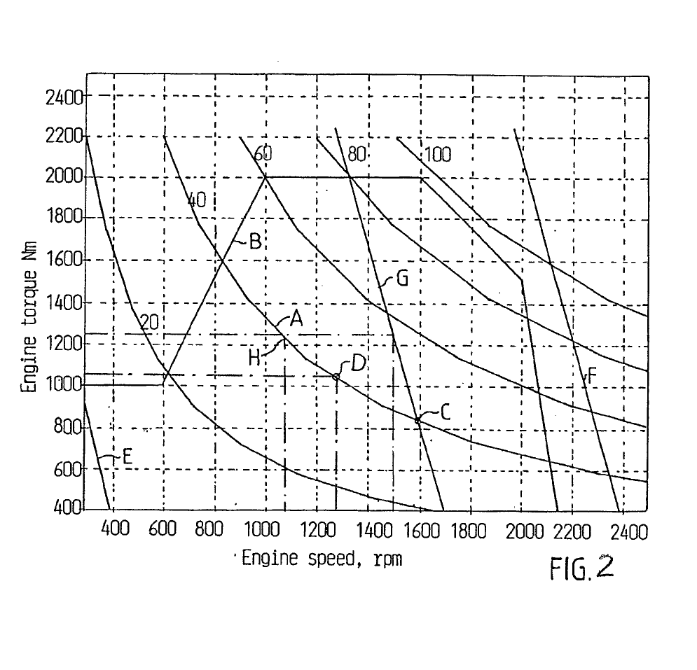

FIG. 2 shows a diagram where two different throttle control characteristics, for controlling the torque as a function of engine speed for various throttle control positions during a selected gear, are respectively controlled along two different sets of curves, which are shown in said diagram. The diagram discloses engine torque on the y-axis and engine speed on the x-axis. Further, the diagram shows throttle control position curves representing 20% up to 100% of full throttle opening. The first set of curves are the vehicle high speed curves indicated A1 to A5 (20% to 100%), and the second set of curves are the vehicle low speed curves indicated with G (and also E and F partly or wholly outside curve B). Curve B only indicates the full load limit of the engine. It must be understood that for clarity reasons only a few of the total number of the vehicle high speed and vehicle low speed curves respectively between 0% and 100% throttle opening has been plotted in the diagram.

At point C on the curve A2 representing 40% of full throttle opening, the engine speed is 1600 r.p.m. and the torque is 820 Nm. With a gear ratio of 1,25:1 for current engaged gear speed, the torque at the output shaft of the gearbox will be 1025 Nm. After shifting up to a gear speed with the ratio 1:1 with constant throttle opening, i.e. still 40%, the engine speed will drop to 1280 r.p.m. at the same time as the torque at the output shaft of the gearbox will rise to 1025 Nm (see point D), i.e. the same torque as prior to shifting. This means that, at constant throttle control position, the output torque from the gearbox, prior to and after shifting between adjacent vehicle high speed gears, will be at least approximately constant. By virtue of the fact that the output torque is the same prior to and after shifting, the unavoidable little break in torque delivery, when the clutch 4 between the engine and the gearbox 9 is released, will be unnoticed, i.e. with minimal jerking, and the acceleration will be experienced as being constant.

As mentioned above FIG. 2 further discloses curves G for driving at vehicle low speed. In FIG. 2 only the 40% throttle opening G-curve is disclosed within the B curve.

According to a preferred embodiment of the invention the engine control unit 15 is programmed to modify said throttle control characteristics from controlling along said vehicle high speed curves, corresponding to a first throttle control characteristic (A-curves), to controlling along said vehicle low speed curves, corresponding to a second throttle control characteristic (G-curve), when the transmission control unit 18 is changing gear from a vehicle high speed gear to a vehicle low speed gear. The opposite modification of the throttle control characteristics will happen when the transmission control unit is changing gear from a vehicle low speed gear to a vehicle high speed gear.

The actual function for controlling the throttle opening as a function of throttle control position and engine r.p.m. can be realized in several ways. It can be done via algebraic algorithms (maps, matrices etc) or dynamic algorithms (transfer functions, differential equations etc) or combinations of the mentioned examples or other known methods. The result of a controlling via one or several of the mentioned methods, when plotted in a diagram like the one in FIG. 2, should be similar to said exemplified vehicle low speed curves and vehicle high speed curves, and according to the invention the change between said throttle control characteristics, and thus curves, is done when changing from a low gear to a high gear or the opposite.

In a further preferred embodiment of the invention said vehicle low speed gears are defined as being the same as vehicle idle driving gears. Idle driving gears are those low gears (one or several of total number of gears) with a high gear ratio where the driver is allowed to idle drive, which means that the transmission control unit holds a gear even if the accelerator pedal is not depressed at all and the engine speed reaches its lower engine speed limit for down shifting. A down shift will not occur when an idle driving gear is engaged and when an engine low speed limit is reached. Idle driving gears are gears where the driver is expected to drive in a constant relatively low vehicle speed. When idle driving, the engine control unit will fuel the engine so that the engine rpm will not decrease further below said lower engine speed limit, thus, killing the engine is avoided.

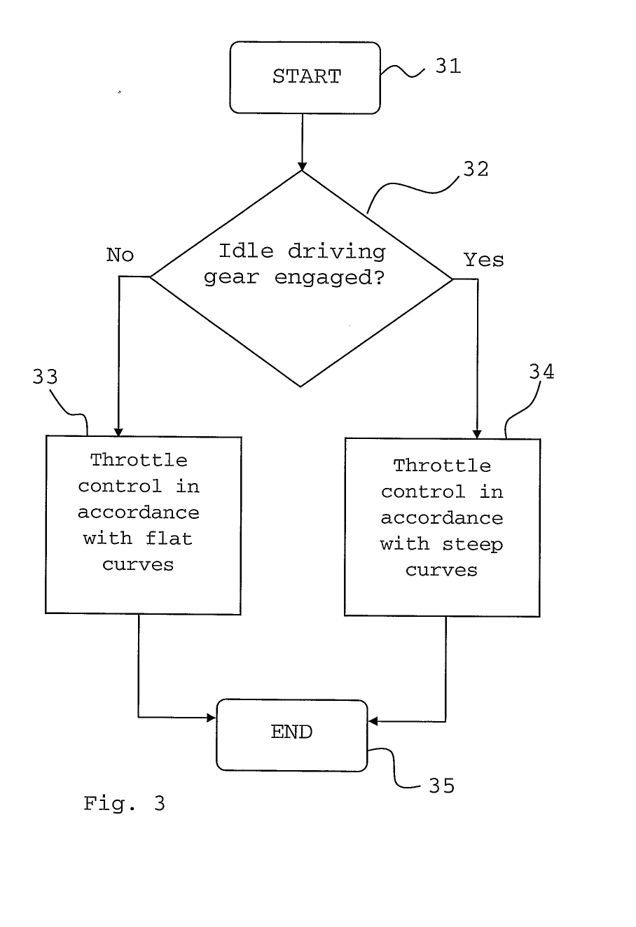

Now follows an example of an embodiment of the invention where a change or modification of said throttle control characteristics is performed. This will be explained with reference to FIGS. 2 and 3. Assume the vehicle is in a low vehicle speed driving with an idle driving gear engaged and the driver is performing a 40% throttle opening, thus, the torque and the engine speed are controlled along the curve G. At point C a gear that is not an idle driving gear is selected and a gear shift is initiated, due to for example engine rpm increase to an upper gear shift rpm limit. The gear shift initiation also starts a sequence—S—for changing throttle control characteristic according to FIG. 3. When the sequence in FIG. 3 is executed the following steps are performed. The sequence starts at 31 and in the next step 32 the transmission control unit checks if an idle driving gear will be engaged or not. If YES the engine control unit 15 will continue to throttle control along curves G as is shown in step 34. If NO the engine control unit will change throttle control characteristic so the throttle control will be performed along curves A2 as is shown in step 33. The sequence in FIG. 3 ends at 35, the new gear is engaged and the throttle control will continue. During gear shifting disengagement and engagement of, the clutch 4 and the engine torque are controlled by the transmission control unit 18.

In a preferred embodiment the transmission control unit 18 switches over the engine control unit 15 to control the throttle opening with throttle control characteristics following one of the steep (G) or flat (A1 to A5) curves. The curves G are preferably as steep as possible to give a smaller speed variation with a corresponding torque change. The curves G cannot, however, be infinitely steep. Essentially, the curves G can be said to be described by y=k*x+m, where y=torque, k=slope and x=r.p.m. If the driving resistance increases at the same time as the driver maintains constant throttle opening, there will be a substantially greater additional torque for a given drop in speed, which is revealed by the diagram in FIG. 2 (curve G). With a driving resistance resulting in a drop in engine speed from 1600 r.p.m. to 1500 r.p.m., the torque will increase from 820 Nm to circa 1250 Nm with control following the steep curve G. For the engine to provide the same torque when controlling along the curve A2, the r.p.m. would have to drop to less than 1100 r.p.m.

The sequence shown in FIG. 3 could be executed every time a gear shift is performed.

In another embodiment the control units 15 and 18 can be replaced with only one control unit or the opposite three or more control units to perform the functions according to the inventive embodiments mentioned above.

In a further embodiment of the invention the transmission 10 could be a manual or semiautomatic gear stepped mechanical transmission.

The invention should not be deemed to be limited to the embodiments described above, but rather a number of further variants and modifications are conceivable within the scope of the following patent claims.

1. A method for modifying throttle control characteristics of a throttle control in a vehicle, the vehicle comprising an engine coupled to engine driven vehicle wheels via a stepped gear mechanical transmission, and where requested engine torque at a given engine speed of the engine is controlled as a function of positions of the throttle control, the method comprising
when sensing a gear shift to a vehicle high speed gear, modifying throttle control characteristics so the engine torque and engine speed will be controlled via the throttle control along a first set of relatively flat curves, when the curves are plotted in a diagram with engine torque on the y-axis and engine speed on the x-axis, and
when sensing a gear shift to a vehicle low speed gear, modifying throttle control characteristics so the engine torque and engine speed will be controlled via the throttle control along a second set of curves, that are steeper than the first set of curves, so that when driving with a vehicle low speed and for a certain change in engine speed, a greater change in torque will be provided than when controlling is done in accordance with the first set of curves.

2. The method as claimed in claim 1, wherein the vehicle low speed gear is an idle driving gear.

3. The method as claimed in claim 2, wherein the idle driving gear is one of two or several predefined idle driving gears and where control of the engine torque and engine speed is done via the second throttle control characteristic, as soon as one of the idle driving gears are engaged.

4. Drive unit for a motor vehicle, comprising an internal combustion engine, a manually adjustable throttle control and an electronic engine control unit for controlling the engine torque and engine speed, and to which the throttle control is electrically connected, and where requested engine torque at a given engine speed of the engine is controlled as a function of positions of the throttle control, a first throttle control characteristic is stored in the engine control unit where engine torque and engine speed will be controlled via the throttle control in accordance with a first set of relatively flat curves, when the curves are plotted in a diagram with engine torque on the y-axis and engine speed on the x-axis, and a second throttle control characteristic is stored in the engine control unit where engine torque and engine speed will be controlled via the throttle control in accordance with a second set of curves, that are steeper than the first set of curves, so that when driving with a vehicle low speed and for a certain change in engine speed, a greater change in torque will be provided than when controlling is done in accordance with the first set of curves, wherein the engine control unit is disposed, when driving with an engaged vehicle high speed gear, to control the engine torque and engine speed via the first throttle control characteristic and, upon a signal indicating that a vehicle low speed gear is engaged, to control the engine torque and engine speed via the second throttle control characteristic.

5. Drive unit for a motor vehicle according to claim 4, wherein the vehicle low speed gear is an idle driving gear.

6. Drive unit for a motor vehicle according to claim 5, wherein the idle driving gear is one of two or several predefined idle driving gears and where control of the engine torque and engine speed is done via the second throttle control characteristic, as soon as one of the idle driving gears are engaged.
